(19) United States
(12) Patent Application Publication
(10) Pub. No.: US 2022/0103593 A1
(43) Pub. Date: Mar. 31, 2022

(54) SYSTEMS AND METHODS FOR SECURING A WORKLOAD

(71) Applicant: Araali Networks, Inc., Fremont, CA (US)

(72) Inventors: Abhishek Singh, Pleasanton, CA (US); Bhanu Gopalasetty, San Ramon, CA (US); Ayaskanta Pani, Fremont, CA (US); Deepak Nulu, Fremont, CA (US); Ashish Kar, Santa Clara, CA (US); Rachita Agasthy, Santa Clara, CA (US)

(21) Appl. No.: 17/325,470

(22) Filed: May 20, 2021

Related U.S. Application Data
(63) Continuation of application No. PCT/US2019/062641, filed on Nov. 21, 2019.
(60) Provisional application No. 62/770,538, filed on Nov. 21, 2018.

(51) Int. Cl. G06F 21/60; G06F 9/54

(52) U.S. Cl. CPC H04L 63/168; H04L 63/20; G06F 9/547

(57) ABSTRACT

The present disclosure provides systems and methods for securing a computer workload. The method may comprise: receiving a workload; embedding a secure agent into the workload, wherein the secure agent comprises (i) a shim layer located between an application libraries layer of the workload and an operating system service layer and (ii) a security policy repository; and implementing security policies based at least in part on application programming interface (API) calls intercepted by the shim layer.

### CROSS-REFERENCE

This application is a continuation of International Patent Application No. PCT/US2019/062641 filed on Nov. 21, 2019, which claims priority to U.S. Provisional Application No. 62/770,538 filed on Nov. 21, 2018, which is entirely incorporated herein by reference

### BACKGROUND

The security of computing devices against internal and external threats such as viruses, malware, network intrusions is a challenge in almost all networked computing environments. To protect computing devices against such threats, networked computing devices are configured with various security settings to prevent unwanted behavior. For example, firewalls are a traditional approach to providing communication security. These firewalls are network devices deployed on customer premises, and configured with access control lists (ACLs), or policies to govern allowed in and out of an endpoint.

With the fast development of IT, the trend towards public cloud, the move to microservices, as well as new application delivery and orchestration mechanisms (e.g., Kubernetes, Docker Swarm® containers) have created new challenges for securing the workloads. For example, virtualization has impacted how virtual machines connect with each other as well as how these communications are secured. In another example, a popular networking technology is creating overlays of multi-tenant network, where each tenant is given an illusion of a virtual private network. On the security front, various approaches have emerged where the firewall function is subsumed by a virtual appliance that is distributed in the network such that it is able to intercept and inspect packets and enforce communication policies. Another security approach is using host native firewalls (e.g., IPTables on Linux) instead of using a separate virtual firewall appliance. In some cases, new firewall paradigms are provided by using host/operating system primitives like eBPF (extended berkeley packet filters) or exploiting system (operating system's) call trapping. Such approaches apply policies at the network layer, although the intent is to control communication between applications and not network endpoints (or IP addresses). However, in the network, identifying the original application from the IP address (e.g., from network header) and port number (e.g., from transport header) is often times error prone. In some cases, secure software development has also been adopted for providing security. Tools and vendors may perform static analysis on the workload and report potential vulnerabilities, insert themselves in the test cycles to perform certain penetration testing to qualify the security readiness of the application, or mitigate risk at runtime by embedding themselves into the application. These approaches, however, may be limited by being difficult to be applied to the policy or access control list approach of securing network communications of applications.

A recent trend in IT is using containers instead of or in conjunction with virtual machines (VMs). Containers are a means of specifying and packaging application workloads such that they can be reliability re-created, run in isolation from each other, and scaled at will. However, the security paradigm for containers is not well established. For instance, container workloads are often short lived (sub-second) and are created on demand in response to input bursts for elastic scaling. A considerable amount of coordination is needed to maintain agility, consistency and speed for managing such workloads with the existing security solutions (e.g., security bolted into hypervisor, host, or network). Another technology is unikernel which builds a unified kernel and application binary with tighter functionality support can be adapted for microservice deployments in place of containers.

The security issues for microservices are also challenging. Modern applications are provided by breaking down monolithic applications into several internal micro-services that can each be individually scaled, secured and evolved. This allows for micro-service reuse, modularity of architecture, and the independence of evolution as well as of upgrades (apart from improving the agility of upgrades). These microservices endpoints may be implemented for other micro-services to interact with, and may not be required to know the end-to-end architecture, resulting in a complex labyrinth of inter-application interactions that is difficult to secure. Given then trend that operations that were once internal function calls have now become network events, the attack surface is greatly increased.

### SUMMARY

Recognized herein is a need for methods and systems capable of providing security to ephemeral or unpredictable workloads at fine grained level. In particular, security is provided without increasing maintenance or management cost. Additionally, security is desired to be applied close to the workload allowing for less permissive and granular policies.

The present disclosure provides a built-in security solution that a workload (e.g., application service) can be secured by embedding a security layer into the workload dynamically. This may be used to provide security that is always available regardless of where and how the security solution is deployed. The built-in security solution may allow for fine grained security control. In some cases the security policy may be applied based on an identity of the entity requesting an access to a resource or an identity/type of the resource to be accessed. For example, instead of allowing access to all the APIs (application programming interfaces), access may be authorized at per API level. For instance, engineers may have read access to one API, whereas human resource may have write access to another API even when both APIs are exposed by the same application. Such per API level policies may be difficult to enforce in a traditional security model (e.g., bolt-on security model) since the communication is usually end-to-end encrypted. Furthermore, application context aware policy which captures current state of an application (e.g., changes to application's authorization level by means of obtained newer credentials or authorization tokens) can also be utilized in the provided system.

Systems and methods may be capable of providing security to ephemeral or unpredictable workload with improved efficiency. For example, modern cloud technologies are running serverless customer workloads, where the placement of workload is usually provided and managed by the cloud service provider that the workload is not known or controlled by the customer. The provided systems and methods may secure the workload by embedding a security layer in the workload thereby eliminating the burden of making assumptions on where the workload might get scheduled to ensure the security fall in the path leading to/from the workload. Additionally, traffic with a built-in security layer may allow for improved network efficiency which is achieved by reducing the necessity of routing the traffic through intermediaries or encrypting the traffic.

In an aspect, a system is provided for securing a computer workload within a network. The system may comprise: a secure agent, and the secure agent comprises an interfacing layer embedded into the computer workload for intercepting application programming interface (API) calls that the secure agent is also configured to apply a security policy based at least in part on the API calls intercepted by the interfacing layer; and a server in communication with the secure agent, and the server is configured to analyze telemetry data captured by the secure agent to secure the computer workload. In some embodiments, the computer workload is a container application or a computing processing that is performed by a bare metal, virtual machine or a combination of Kubernetes and server.

In some embodiments, the interfacing layer is a shim layer that is located between an application libraries layer of the computer workload and an operating system service layer. In some embodiments, the interfacing layer comprises a dynamically linked library.

In some embodiments, the telemetry data comprises application contextual data, metadata or flow telemetry data. In some embodiments, the server is configured to perform behavioral analysis based on the telemetry data. In some embodiments, the server is configured to monitor and record a history of the telemetry data at an API level. In some embodiments, the security policy is applied based on an identity of the entity requesting the access to the resource or an identity of the resource to be accessed.

In some embodiments, the server is configured to monitor and record a history of the telemetry data at an API level. In some embodiments, the secure agent is cryptographically secured.

In some embodiments, the secure agent is in communication with an interceptor, and wherein the interceptor is configured to intercept a data flow and apply the security policy on the data flow. In some cases the interceptor and the secure agent forms a master-slave relationship. In some embodiments, the secure agent comprises a memory unit to store data related to a policy state, a firewall state and the telemetry data. In some embodiments, the secure agent is configured to perform packet interception or packet inspection.

In some embodiments, the security policy is applied at Layer-7 of the OSI (Open Systems Interconnection) Network model. In some cases, the security policy is a location-transparent policy. In some cases, the security policy specifies a connection between two entities in the network. In some cases, the security policy comprises a service policy specifying a connection in a service or an environment policy specifying a connection permitted in an environment. In some embodiments, the security policy is automatically derived from the telemetry data.

In another aspect, a method is provided for securing a computer workload within a network. The method may comprise: receiving the computer workload in the network; embedding a secure agent into the computer workload, and the secure agent comprises an interfacing layer for intercepting application programming interface (API) calls; and applying, based at least in part on the API calls intercepted by the interfacing layer, a security policy to secure the computer workload.

In some embodiments, the computer workload is a container application or a computing processing that is performed by a bare metal, virtual machine or a combination of Kubernetes and server. In some embodiments, the interfacing layer is a shim layer that is located between an application libraries layer of the computer workload and an operating system service layer.

In some embodiments, the secure agent is configured to capture telemetry data and transmit the telemetry data to a server for further analysis. For instance, the telemetry data comprises application contextual data, metadata or flow telemetry data. In some cases, the method further comprises processing the telemetry data and granting an access to a resource within the network based on the security policy. For example, the security policy is applied based on an identity of the entity requesting the access to the resource or an identity of the resource to be accessed.

In some embodiments, the security policy is automatically derived from telemetry data captured by the secure agent. In some embodiments, the server is configured to perform behavior analysis on the computer workload based on the telemetry data or monitor and record a history of the telemetry data at an API level.

In some embodiments, embedding the secure agent comprises using a dynamic linking approach, a lazy binding technique or a dynamic binary modification method. In some embodiments, the method further comprises registering and verifying the secure agent cryptographically via a handshake process. In some cases, the method may use a nonce to protect the handshake process against a replay attack. In some cases, the handshake process comprises verifying the secure agent by a peer node.

In some embodiments, the interfacing layer comprises a dynamically linked library. In some embodiments, the security policy is applied at Layer-7 of the OSI (Open Systems Interconnection) Network model. In some embodiments, the security policy specifies a connection between two entities in the network. In some embodiments, the security policy comprises a service policy specifying a connection in a service. In some embodiments, the security policy comprises an environment policy specifying a connection permitted in an environment.

In some embodiments, the secure agent is in communication with an interceptor, and wherein the interceptor is configured to intercept a data flow and apply the security policy on the data flow. In some cases, the interceptor and the secure agent forms a master-slave relationship. In some cases, the data flow comprises application contextual data.

In some embodiments, the secure agent comprises a memory unit to store data related to a policy state, a firewall state and a telemetry data. In some embodiments, the secure agent is configured to perform packet interception or packet inspection. In some embodiments, the method further comprises attesting the workload using a nonce and a security key through an inter-process communication socket. In some embodiments, the method further comprises performing one or more actions upon executing the security policy, and wherein the one or more actions comprises alerting a malware.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically shows an example of a workload.

FIG. 2 schematically illustrates a workload integrated with a secure agent, in accordance with some embodiments of the invention.

FIG. 3 schematically illustrates an environment in which a secure management system and secure agents are operated.

FIG. 3A schematically illustrates an example of a secure management system employing a fog layer.

FIG. 4 schematically shows a block diagram of an exemplary secure agent, in accordance with various embodiments of the invention.

FIG. 5 shows an exemplary internal process of implementing security policies with a secure agent.

FIG. 6 shows an example of converting insecure workload into a secure workload.

FIG. 7 shows a computer system that is programmed or otherwise configured to implement a security management system.

FIG. 8 schematically shows various deployments of a secure agent and an interceptor process.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Certain Definitions

Unless otherwise defined, all technical terms used herein have the same meaning as commonly understood by one of ordinary skill in the art to which this invention belongs.

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” “unit” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Embodiments of the invention may be used in a variety of applications. Some embodiments of the invention may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, a wireless communication station, a wireless communication device, a wireless access point (AP), a modem, a network, a wireless network, a local area network (LAN), a virtual local area network (VLAN), a wireless LAN (WLAN), a metropolitan area network (MAN), a wireless MAN (WMAN), a wide area network (WAN), a wireless WAN (WWAN), a personal area network (PAN), a wireless PAN (WPAN), a virtual private network (VPN), a storage area network (SAN), a frame relay connection, an Advanced Intelligent Network (AIN) connection, a synchronous optical network (SONET) connection, devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or long term evolution (LTE) of the above standards, units and/or devices which are part of the above networks, one way and/or two-way radio communication systems, cellular radio-telephone communication systems, a cellular telephone, a wireless telephone, a personal communication systems (PCS) device, a PDA device which incorporates a wireless communication device, a multiple input multiple output (MIMO) transceiver or device, a single input multiple output (SIMO) transceiver or device, a multiple input single output (MISO) transceiver or device, or the like.

It is noted that various embodiments can be used in conjunction with one or more types of wireless or wired communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, multi-carrier modulation (MDM), discrete multi-tone (DMT), Bluetooth®, ZigBee™, or the like. Embodiments of the invention may be used in various other devices, systems, and/or networks.

Systems and methods of the present disclosure may provide a built-in security model. In some embodiments, the built-in security model may include a secure agent embedded into a workload (e.g., application service) and a backend system in communication with the secure agent. This may be used to provide security that is always available and with fine control.

Systems and methods may be capable of providing security to short-lived or ephemeral workload with improved efficiency. The provided systems and methods may be applied to various types of workloads. A workload may also be referred to as computer workload throughout the specification.

In some embodiments, a computer workload (e.g., application, server software, software development environment, software test environment) is a unit of computing processing that is performed via an IaaS, PaaS, or SaaS. For example, IaaS may comprise instances of Microsoft, Windows or Linux running on a virtual computer, or a Desktop-as-a-service (DaaS) provided by Citrix® or VMWare®; a PaaS may comprise a database server (e.g., MySQL® server), Samba server, Apache® server, Microsoft® IIS.NET server, Java® runtime, or Microsoft® .NET® runtime, Linux-Apache-MySQL-PHP (LAMP) server, Microsoft® Azure, or Google® AppsEngine; a SaaS may comprise SalesForce®, Google® Apps, or other software application that can be deployed as a cloud service, such as in a web services model. A cloud-computing resource may be a physical or virtual computing resource (e.g., virtual machine). In some embodiments, the cloud-computing resource is a storage resource (e.g., Storage Area Network (SAN), Network File System (NFS), or Amazon S3®), a network resource (e.g., firewall, load-balancer, or proxy server), an internal private resource, an external private resource, a secure public resource, an infrastructure-as-a-service (IaaS) resource, a platform-as-a-service (PaaS) resource, or a software-as-a-service (SaaS) resource. Hence, in some embodiments, a cloud-computing service provided may comprise an IaaS, PaaS, or SaaS provided by private or commercial (e.g., public) cloud service providers. In some cases, a computer workload may be a container application, a virtual machine-based application, or any computing processing that is performed by a bare metal, virtual machine, a combination of virtual machine or kubernetes-api-server.

In some cases, a computer workload may be a containerized application (e.g., application container or service containers). The application container may provide tooling for applications and batch processing such as web servers with Python or Ruby, JVMs, or even Hadoop or HPC tooling. Application containers are what developers are trying to move into production or onto a cluster to meet the needs of the business. Methods and systems of the invention will be described with reference to embodiments where container-based virtualization (containers) is used. However, it is to be understood that the container application is just an example workload, without suggesting any limitation as to the scope of the invention. The methods and systems can be applied to any type of workload provided by any type of systems (e.g., containerized application, unikernel adapted application, operating-system-level virtualization or machine level virtualization).

In some cases, a workload may be integrated with an embedded secure agent. The secure agent may interact with a backend security management system to provide telemetry and/or to fetch the security policy for the workload. A secure agent can be referred to as an embedded secure agent which are interchangeably used throughout the specification.

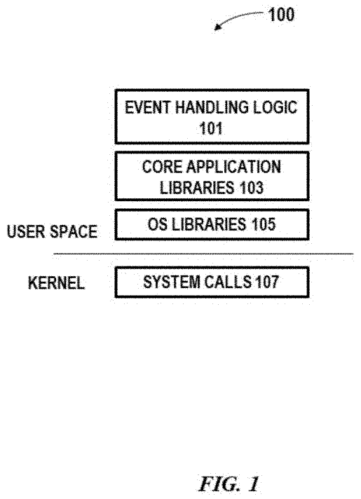

FIG. 1 schematically shows an example of a workload 100. The workload 100 can be any workload as described above where a security agent can be embedded. For example, a workload may be an application consisting of either a single process or a collection of processes working together to provide a service. User space can be a system memory allocated to running applications while the kernel provides certain services. The user space may be used by libraries and application programs. In an example, programs in user space may contain system calls that ask the kernel to perform certain functions, and the kernel may perform the functions as requested or return an error code. The kernel services and core of the kernel may or may not run in a higher privileged mode.

An application or workload may have layers of software as shown in FIG. 1. As illustrated in FIG. 1, a workload such as an application 100 may comprise an event handling logic 101 (e.g., application event handling logic core) that processes incoming events. The event handling logic 101 may be coupled to the core application libraries layer 103 that helps process the events such as storing data in a database, querying a database, or communicating with another process and the like. The core application libraries layer 103 may be statically linked into the process binary. The core application library may comprise application code.

The OS (operating system) libraries layer 105 may provide access to system resources such as memory, storage, and network. The OS libraries layer 105 may comprise, for example, the Secure Socket Layer (SSL) APIs for cryptographic operations. The OS libraries layer 105 may comprise (C Runtime) libraries such as GLibC and OpenSSL on Unix like Operating Systems, and msvcrt (Microsoft Visual C/C++ Runtime) and OpenSSL on the Windows Operating Systems. The OS libraries layer 105 may provide a set of standards, backward compatible, clean APIs for applications programs. Besides the OS provided system libraries, other important libraries (e.g., ‘matlab’) may also be included in the user space. It should be noted that the provided security model can be integrated with other entities such as DPDK (Intel's DataPath Development Kit) which is a mechanism to bypass/augment the kernel networking stack. These APIs may call kernel provided System Calls 107 to access the system resources. Both the OS libraries and system call layer code may still run in the context of the application process, although the system calls may be executed in privileged mode. In some cases, libraries in the OS (operating system) libraries layer 105 may be dynamically linked to the process during its execution.

The workloads can be ephemeral, dynamic, or unpredictable. In some cases, the workload may be a container application. Container applications are a type of computer application that leverages a form of virtualization. Unlike virtual machines, in which both a guest operating system kernel and the user space are virtualized on a per-virtual machine basis, container applications utilize separate user spaces with a shared host operating system kernel space.

Container based microservices are often used as modular, open source pieces that may be combined and shared to build an application. For example, container applications for performing specific or common tasks may be created and then shared in repositories so that unrelated entities may take and incorporate the container applications into their own computing environments.

The user space may affect applications. The user space is where the language runtimes exist. For example, the user space may be packaged up inside the container image and shared between developers, architects, and system administrators. In some cases, a host operating system may allow for multiple isolated user-space instances (e.g., containers using isolated kernel namespaces) to run in host operating system (e.g., a single operating system instance).

The provided security solution may integrate firewall functions with the workload (e.g., container application), where the data is clean. Clean data may refer to clean and unencrypted data. In some cases, clean data may include, without limitation, application contextual data and/or associated metadata. For example, the clean data may include process lineage, process's executable a.k.a binary image version/checksum, operating-system type/version, environment variables of an application, container or virtual-machine metadata (e.g., container's image id/version), zone or vCenter tags associated with the application and/or kubernetes selectors associated with the application's running instance and the like.

A network firewall may enforce a set of rules that govern what data streams, or packets, are permitted to enter or leave a network based on one or more fields in the packet. Such firewall function is traditionally performed by optimized independent entities that sit in the path of the data packet, such as Palo Alto Next Generation Firewall, Cisco Advanced Security Appliance, or OS native packet filters (IPTables in Linux, or NetSh Firewall in Windows). However, such traditional approach may not work well with workloads that are ephemeral, dynamic, or unpredictable.

The present disclosure provides a built-in security layer (i.e., secure agent) in a workload providing an interface where security policies can be applied, and which further interacts with a backend security management system to provide telemetry and/or fetch the security policy for the workload. The firewall policy enforced by the secure agent may be the same as existing firewall policies. For example, the firewall policy can include any security policies including but not limited to, a simple access policy (permit/deny, or rate-limiting), or a simple anomaly engine that works in concert with the backend system (e.g. detect/alert/mitigate data exfiltration when more than normal amount of data is seen to be transferred outside). Alternatively or in addition to, the firewall policy can include policies based on data of layer-7 (Application Layer of Open Systems Interconnection Network model) information such as http headers, URL (RPC/REST-api endpoint, topics, or application signatures, metadata and other data extracted from the workload.

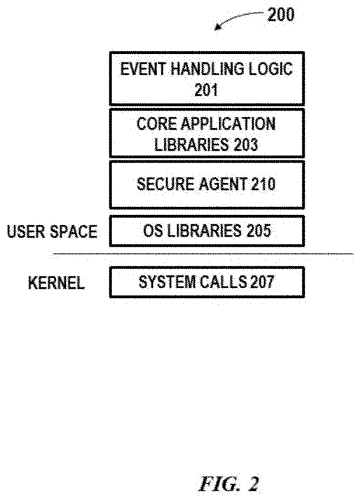

FIG. 2 schematically illustrates a workload with a secure agent 200. The secure agent 210 may be embedded into the workload by injecting a shim layer into the workload. A shim can be a small library that transparently intercepts API calls and changes the arguments passed, handles the operation itself or redirects the operation elsewhere. In some embodiments, the shim layer may be located between an application libraries layer of the workload and an operating system service layer. For example, the secure agent 210 may be injected at the interface between the core application libraries layer 203 and the operating system libraries layer 205. The core application libraries layer 203 and the operating system libraries layer 205 can be the same as the core application libraries layer and OS libraries layer as described in FIG. 1. Similarly, event handling logic 201 and system calls 207 can be the same as the event handling logic and system calls as described in FIG. 1.

The secure agent 210 or shim layer may function as the OS libraries layer to interface the core application libraries layer, providing the same API constructs, and call the OS services APIs on the application's behalf and the like. Alternatively or in addition to, the secure agent may be a process intercepting network connection sourced from or destined to the application.

The secure agent 210 may be used to implement network firewall functionality to provide security in a network. For example, the secure agent 210 or shim layer may provide wrapper APIs/routines to create and destroy network sockets, and to send and receive data to/from these sockets. In some cases, the secure agent may be a library that is built into the application binary. Since the shim layer sits above the OpenSSL library as well, it may have access to the clean data where the data is clean and/or unencrypted. As described above, clean data may include, for example, application contextual data and/or associated metadata. For instance, the clean data may include process lineage, process's executable a.k.a binary image version/checksum, operating-system type/version, environment variables of an application, container or virtual-machine metadata (e.g., container's image id/version), zone or vCenter tags associated with the application and/or kubernetes selectors associated with the application's running instance and the like. The shim layer may apply policies at Layer-7 of the OSI (Open Systems Interconnection) Network model, such as at a REST API level, at gRPC (Remote Procedure Calls) transaction level, at the level of Kafka® topics, SQL queries and various others. Components of the secure agent and the firewall functions performed by the secure agent are described later herein.

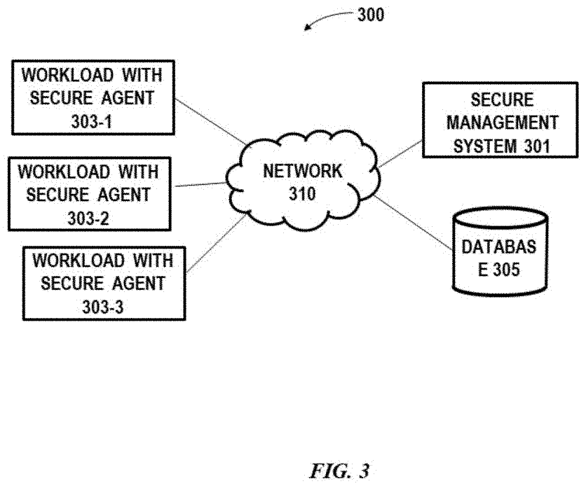

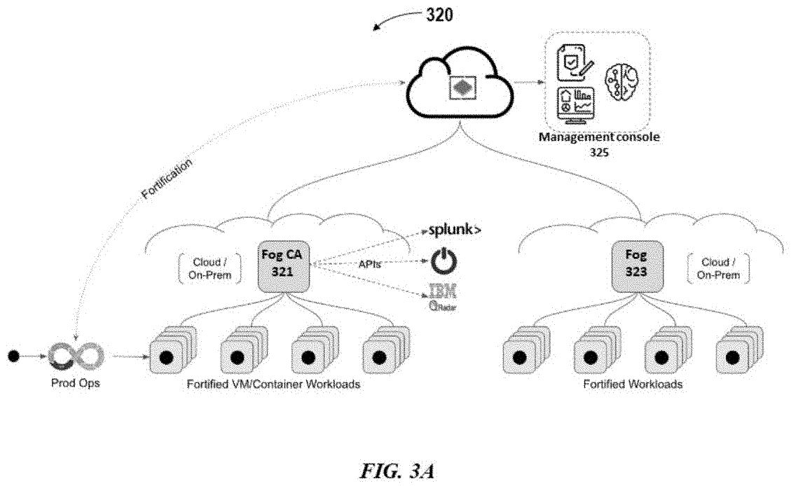

The provided security solution may be implemented by employing a plurality of built-in secure agents in communication with a backend secure management system. FIG. 3 schematically illustrates an environment 300 in which a secure management system and secure agents are operated. As described above, a workload may be integrated with a secure agent 303-1, 303-2, 303-3. The secure agent(s) may communicate with the secure management system 301 over a network 310. In some cases, the secure agent may be configured to apply security policies, provide real-time telemetry to the secure management system 301 for further analysis and/or fetch security policies from the secure management system 301. Real-time as used herein may generally refer to a response time of less than 1 second, tenths of a second, hundredths of a second, or a millisecond, such as by a computer processor.

In some cases, realtime telemetry data may be captured by the secure agent. The telemetry data may be used to derive security policies in an automatic fashion. The telemetry data may be application contextual data and/or flow telemetry data that captures rich contextual information about the communicating peers. Flow telemetry data may contain ephemeral information such as flow time stamp and/or statistics, environment, process binary or parent binary, process arguments and other associated run-time tags. The telemetry data such as application contextual data can be fetched using various mechanisms. For example, the secure agent may utilize the netlink and linux/proc/<pid> tree to find out about an intercepted flow's origination or destination process (application) and use that information to glean context about the process from the system. In another example, the secure agent may fetch its own application/process context in a native manner as the secure agent is co-resident and runs inside the process run-time space. In another example, the secure agent may be in communication with another process such as interceptor process which provides data path redirect for intercepting flows and applying policy on these flows. For instance, the secure agent may establish a side channel to the interceptor and send its local process application context in a serialized manner to the interceptor which caches this data stream. The secure agent may also send flow tuple information (e.g. TCP/UDP flow case local and remote ip address and layer-4 port numbers) in a serialized manner to the interceptor process via the side channel. The information on the side channel may be sent using a dedicated connection to the interceptor and can be different from the application's socket (flow channel). The interceptor may then retrieve the tuple information from the intercepted flow and look-up the information gleaned from the side channel to derive corresponding process's application contextual data. In a further example, the application context data may be sent in-band on the flow socket channel such as via the application data channel without using a side channel, to the interceptor. The interceptor may glean the application contextual data from this flow's byte stream, use it for authentication/authorization and remove it from the stream before forwarding the rest of the streamed data on this data flow socket channel to its destination.

In certain scenarios such as when employing Kubernetes, a set of containers may share the network namespace but not share the application process and root-file-system where the interception cannot be applied directly. In such cases, a slave agent can be employed which shares the namespace of the application process. The slave agent may establish a control channel communication with the master secure agent and provide the application contextual data on an on-demand basis in response to a request from the master agent. The above-mentioned slave agent and/or method can be well-applied to a distributed set of compute nodes in addition to the namespace and Kubernetes scenarios. For example, in the case of virtual machine/bare metal (VM/BM), network flow interception may be performed by providing a default gateway in the application server network, requesting the application contextual data from another remote VM/BM server, and providing data-path functionality along with enhanced security based on the application contextual data (i.e., telemetry data).

In some embodiments, the secure management system 301 may be configured to provide security policy management, behavior analysis of workloads, audit and alerting system to an operator/administrator, and various others. For example, the secure management system 301 may update Blacklist signatures on the fly, manage Blacklist policies (e.g., traditional firewall policies, per API policies, or customized policies) or Whitelist Policies (e.g., Zero Trust policies), discover new signatures from an external threat feed, or update policies based on user (e.g., operator/administrator) provided changes. In some cases, one or more actions may be performed by the secure agent upon executing a security policy. The one or more actions can be performed may include, for example, blocking, alerting, and/or sending related information to secure a host, a virtual machine (VM), and/or a container. The one or more actions may include a list of signaling actions such as: block and/or alert on all traffic and isolate host or VM from the network; block and/or alert on only malware traffic from the host or VM; block and/or alert on malware lateral movement on the network; and send specific security configuration to secure the host, virtual machine or container.

In some cases, the secure management system 301 may monitor and record a history of flow data at the API/transaction level (e.g., byte count, packet count type information) for audit or forensics. In some cases, the flow data may be tracked by the secure agent and reported/transmitted to the secure management system 301 periodically. In some cases, the secure management system 301 may perform analytics and forensics of the telemetry provided by the embedded secure agents. For instance, the secure management system 301 may extract forensic intelligence from data transmitted by the secure agents. The security management system may, for example, identify anomalous patterns based on baseline data where the baseline data may be application behavior extracted from historical data. The secure management system 301 may utilize any suitable techniques such as statistical clustering/anomaly/correlation, machine-learning or artificial intelligence-based techniques for performing the afore-mentioned tasks.

The security management system may receive telemetry data transmitted from a secure agent. The telemetry data may be transmitted on pre-determined schedule (e.g., periodically) or upon detection of an event. In some cases, the secure agent may be configured to transmit telemetry data that includes at least flow data and metadata. The flow data may include parsed data such as the destination the application is trying to reach, a network source address, Internet Protocol (IP) address, Media Access Control (MAC) address, Domain Name System (DNS) name, source port, destination address, destination port, protocol type, class of service, and Layer-7 information such as http headers, URL (RPC/REST-api endpoint, topics, or application signatures). In some cases, metadata such as application type, Kubernetes labels, process lineage, binary/executable checksum, environment variables, and the like may also be included in the telemetry data and transmitted to the security management system for further analysis.

In some cases, the secure management system 301 may be configured to manage the secure agents such as deploying the secure agents and/or registering secure agents. Secure agent may first register with the secure management system 301 to establish a channel for communication with the secure management system 301. During the registration or verification process, system and method of the disclosure may utilize cryptographic technologies such as Transport Layer Security (TLS) or Secure Sockets Layer (SSL) to provide secure connections over the network. According to SSL protocols, session information between endpoints of a connection such as an SSL client and an SSL server are negotiated through a handshake phase and the identity of the SSL server is verified by the SSL client. For example, the initial certificate for this handshake may be embedded into the secure agent and may be refreshed periodically. During the deployment, the secure management system 301 may keep track of all workloads being spawned. In some cases, if a secure agent does not register or is not verified, it may be flagged and quarantined immediately. The secure agent may then store and manage the signed certificate associated with the endpoint or workload in a local database. In some cases, the certificate may be used for establishing secure channel among workloads or secure agents. For instance, the secure agent may verify if the certificate with another workload is a valid certificate based on the digital signature included in the certificate. The handshake can be used to exchange information in a secure way such that the identities and information that policy relies upon cannot be spoofed. This beneficially provides non-repudiation of transferring policy and related information. In an exemplary process, the initial certificate for the handshake maybe provided to an agent after attestation that agent is a legitimate application allowed to run in the environment where it is currently running. The cryptographic keys associated with the certificate can be generated by the secure-agent and the certificate issued is digitally signed by the secure management system with its own root certificate.

In some cases, the process of attestation can be done by utilizing host-agents and/or deployment specific agents (e.g., kubernetes-api-server, kubectl agent) or vCenter information. In general, an attestation is a statement by an attestor that a container image is ready for deployment and the attestor may sign the image if it passes the attestation. In some cases, metadata for attestation maybe gathered. The digital signing of the certificate by the secure management system 301 can be achieved by using any suitable techniques such as Intel-SGX or other techniques that provide high level protection for cryptographic function implementation by providing a secure enclave even when such signing application runs in a cloud provider environment (e.g., Amazon-AWS, Microsft-Azue or Google-GCE). Unlike conventional attestation mechanism, the provided attestation may not rely on IP address such that it may be conveniently applied to the scenarios wherein shared-IP is used. Details about attestation are described later herein.

Generation and verification of the handshake signature (e.g., including at least part of application contextual data and security credentials) can be a time-consuming process. In some cases, the provided system may employ caching to improve the exchange and verification process. For instance, a sender may, for a first time, create a cached entry of the handshake payload and store it for sending in future to a peer node that may or may not in communication with before. This may beneficially allow for a faster exchange of handshake payload as the process of application context fetch, security key generation and attestation with management module may not be required for the future handshake. A receiving peer node may cache the handshake payload after an initial verification. In the subsequent exchange and verification process, the receiving peer may simply compare the cached handshake payload to incoming payload to determine if the handshake payload sent is trust worthy that may not require modification. Alternatively or in addition to, in the subsequent exchange and verification process, a sender may send a session-id (e.g., an assigned ID for a given peer's handshake) and only that session-id may be exchanged instead of the entire payload.

In some cases, the handshake process may be followed by a short challenge authorization process in order to protect the handshake process or the verification process against replay attacks by an eavesdropper. For example, the handshake message may be used to send the application context and associated public certificate payload, as well as a randomly generated nonce value. Each peer node may send a digital signature of the sender's nonce and send it back in the final message of handshake process thus proving to the other peer nodes that it has the private key corresponding to the public key sent in the handshake payload's public key section. The public private key can be any type of asymmetric cipher such as RSA or Elliptical curve. The public private key can also be based on a shared-secret based symmetric cipher. The digital signature can utilize any suitable mechanism such as symmetric (shared secret) or asymmetric cipher mechanism using the public/private key based mechanism.

In some embodiments, the secure agent may employ various mechanisms to identify if the peer side is verified by the security system. For example, the secure agent's IP Addresses may be distributed to the plurality of secure agents of the system by using a backend fanout mechanism. Alternately, flow's data may be analyzed using a carrier sensing approach. For instance, prior to establishing a TCP connection, a server may examine the received payload's digital signature, application context and determine if they match the signature protocol (e.g., proper-prefix of a signature generated by the secure management system) and IP address.

The security agent may be injected in the application stack in a seamless and frictionless manner. The secure management system 301 may receive a request for transforming/converting a workload into a secure workload. In some cases, the request is initiated by a service provider or endpoint of the network. The secure management system 301 may receive a workload (provided by the service provider) as input and output a secure workload embedded with a secure agent. As described above, the secure agent may be an embedded shim library which is a dynamically linked library that becomes the gateway or access layer to the original OS services library. The shim layer or secure agent can be injected using various suitable approaches.

For example, the shim layer may be embedded into a workload using a dynamic linking approach. For instance, the shim layer may be injected as a new dynamically linked library into the input container application. The API names and signatures provided by the shim layer should be compliant and imitate the real services library so that changes to the application code are not required. The shim layer may be a replacement for the original OS services library that the container application may go through the shim layer to access the services offered by the platform (OS) service. For instance, the shim layer may be injected by lazy binding technique. The container application may first bind with the shim layer and then delegate to the system provided library for APIs that are not trapped by the shim layer. The shim layer, after applying prescribed policies and validating the parameters, calls the original APIs for the APIs that are being trapped. This dynamic linking approach works for applications written in various interpreted language such as Python, Perl, Ruby, Java Script, PHP or compiled languages such as C, C++, Java and the like. This dynamic linking approach works well with most of these languages typically run on top of a C runtime which is usually glibc and openssl.

The secure agent or shim layer may also be injected into statically linked applications (workloads). Various suitable methods may be employed to embed a secure agent into statically linked applications in a seamless or frictionless manner. For example, the secure agent may be embedded by dynamic binary modification method. This method may require minimal changes to the application source code, or in the process by the application is built. For example, since the OS Service library is built statically into the application binary itself, the dynamic binary modification method may be performed by parsing the binary (ELF formatted in case of Linux operating systems) executable, identifying the respective call to the underlying system calls, e.g. kernel services or the equivalents and replacing them with the secure shim wrapper function call. This is beneficial for improving performance by instrumenting at a minimum level in order to provide a firewall function. In another example, an application writer may be provided with a secure agent library and get involved during the application building process. This process may require a re-compile and/or re-linking of application code.

In some cases, an additional agent functioning as guarantor or co-resident agent may be provided. The co-resident agent may be configured to process workload that does not have an embedded secure agent in order to ensure that policies can be applied to all traffic. The co-resident agent may allow workload without embedded secure agent can also benefit from the distributed firewall and policy paradigm.

Referring back to FIG. 3, the secure management system 301 may comprise one or more servers and one or more database systems 305 which may be configured for storing or retrieving relevant data. Relevant data may comprise the telemetry data provided by secure agents (e.g., destination the application is trying to reach, the port number, layer-7 information such as http headers, URL, RPC/REST-api endpoint, topics, or application signatures, metadata such as user), secure agents data (e.g., registration information, verification information, certificates, etc) and various other data as described elsewhere herein. In some instances, the secure management system 301 may receive data from the database systems 305 which are in communication with the one or more external systems.

In some embodiments, the database systems 305 may comprise a policy database as a repository for network policy or security policy. The policy database may utilize various database structures such as a normalized relational database or NoSQL database. Policies can be established external to a network system. In some cases, a network administrator can manually change the policies. Policies can dynamically change and be conditional on events or workload. In some cases, the policy (table) may be pushed to selected secure agents or all of the secure agents in communication with the security management system.

The one or more databases 305 may utilize any suitable database techniques. For instance, structured query language (SQL) or “NoSQL” database may be utilized for storing telemetry data provided by secure agents, security policies, certificates or other data. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

Each of the components (e.g., servers, database systems, computer devices, external systems, and the like) may be operatively connected to one another via one or more networks 310 or any type of communication links that allows transmission of data from one component to another. For example, the respective hardware components may comprise network adaptors allowing unidirectional and/or bidirectional communication with one or more networks. For instance, the servers and database systems may be in communication—via the one or more networks 310—with the endpoint devices, service providers, and/or data sources to transmit and/or receive workloads and relevant data.

The security management system 301 may be implemented on a server. A server may include a web server, a mobile application server, an enterprise server, or any other type of computer server, and can be computer programmed to accept requests (e.g., HTTP, or other protocols that can initiate data transmission) from a computing device (e.g., user device, other servers) and to serve the computing device with requested data. A server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In addition, a server can be a broadcasting facility, such as free-to-air, cable, satellite, and other broadcasting facility, for distributing data. A server may also be a server in a data network (e.g., a cloud/fog computing network).

A server may include various computing components, such as one or more processors, one or more memory devices storing software instructions executed by the processor(s), and data. A server can have one or more processors and at least one memory for storing program instructions. The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods can be implemented in hardware components or combinations of hardware and software such as, for example, ASICs, special purpose computers, or general purpose computers.

In some embodiments, the security management system 301 may construct the database 305 in order to deliver the data (e.g., policy data) to the secure agents or users efficiently. For example, the security management system 301 may provide customized algorithms to extract, transform, and load (ETL) the data. In some embodiments, the security management system 301 may construct the databases using proprietary database architecture or data structures to provide an efficient database model that is adapted to large scale databases, is easily scalable, is efficient in query and data retrieval, or has reduced memory requirements in comparison to using other data structures.

The security management system may be implemented anywhere in the network. The security management system may be implemented on one or more servers in the network, in one or more databases in the network, one or more service providers or one or more endpoint devices. For example, the security management system may be implemented in a distributed architecture (e.g., a plurality of devices collectively performing together to implement or otherwise execute the security management system or its operations) or in a duplicate manner (e.g., a plurality of devices each implementing or otherwise executing the security management system or its operations as a standalone system). The security management system may be implemented using software, hardware, or a combination of software and hardware in one or more of the above-mentioned components within the network environment 300. The security management system may be implemented as a standalone system or integral to an endpoint of the network (e.g., service provider).

The network 310 may be a communication pathway between the security management system 301, a workload provider (e.g., endpoints of the network, container host platform, cloud service provider, or other platforms), or other components of the network. The network may comprise any combination of local area and/or wide area networks using both wireless and/or wired communication systems. For example, the network 310 may include the Internet, as well as mobile telephone networks. In one embodiment, the network 310 uses standard communications technologies and/or protocols. Hence, the network 310 may include links using technologies such as Ethernet, 802.11, worldwide interoperability for microwave access (WiMAX), 2G/3G/4G or Long Term Evolution (LTE) mobile communications protocols, Infra-Red (IR) communication technologies, and/or Wi-Fi, and may be wireless, wired, asynchronous transfer mode (ATM), InfiniBand, PCI Express Advanced Switching, or a combination thereof. Other networking protocols used on the network 310 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above. The network may be wireless, wired, or a combination thereof

In another deployment scenario, the secure management system can be a multi-tenant aware providing afore-mentioned services to multiple tenants simultaneously while providing secure isolation of information related to policy and telemetry data among the multiple tenants. For example, the secure management system may allow for automatic policy derivation for each tenant and/or workload individually. Details about deriving policies based on realtime telemetry data are described later herein.

As mentioned above, a secure management system may include services or applications that run in the cloud or on-premises environment. In some cases, the secure management system may comprise a software-based solution based on fog computing concepts which extends some of the tasks performed by the secure management system closer to the edge (e.g., workloads). Maintaining close proximity to the edge (e.g., workloads, virtual machines, data centers, etc) may significantly reduce overall bandwidth requirements and the cost of managing widely distributed networks. The provided secure management system may employ fog computing paradigm that at least a portion of secure tasks can be performed at the edge. For example, tasks performed by a fog layer between the cloud/SaaS and the secure agent may include, but not limited to, security policy management, behavior analysis of workloads, workload attestation for non-repudiation to attest workloads against known sources of truth (e.g., kubernetes master, VmWare, vCenter), proxying of traffic out of demilitarized zone, sandboxing and live baselining to help with attesting workloads as belonging to the original package of application delivery, co-resident with existing firewall, manage or update the secure agent, and various others as described elsewhere herein. Alternatively, one or more of the aforementioned tasks can be performed by a management console of the secure management system running in the cloud (e.g., cloud application).

In some cases, the secure agent upgrades can be performed without bringing the workload down or bringing the host link down, thus improving the performance of the network or traffic. The secure agents may be upgraded dynamically without causing service disruption. In some cases, the upgrade of the secure agent may be performed automatically according to a scheduled upgrade plan. The upgrade plan may comprise, for example, a scheduled date, plan description and one or more entries describing how the upgrade may affect various secure agents on workload side or an action to be performed by the secure agent. The upgrade plan can be managed, modified, created by a user and may be saved in a database accessible to the secure management system.

The secure agent may be upgraded in a seamless manner without interrupting the traffic or service. The upgrade process may follow a hand off mechanism to ensure the order of packet being sent. For example, the secure agent to be upgraded to a new version may download the newer version based on an event trigger (e.g., a direct service command, a scheduled event according to the upgrade plan). The running version of the guarantor process may fork a child process and execute the new version of guarantor binary on the child process. It may also pass down all the existing file-descriptors corresponding to intercepted socket flows and/or forward socket flows to child process. The child process may be attested with the fog CA and built its internal data-structures based on the file-descriptors to be passed from the parent to the child process, and the child process may declare it is ready to handle flow processing by signaling the parent process. The parent process may not perform read actions from any of the socket file-descriptors during this process while the parent process may finish writing to all the file-descriptors before signaling the child process to take over. Upon receiving the signal from parent, the child process may resume all read/write on the socket's normal manner. At this point the parent process may proceed to close all its file-descriptors and exit to complete the seamless upgrade process.

FIG. 3A schematically illustrates an example of the secure management system employing a fog layer 321, 323. In the illustrated example, a certificate authority (CA) 321 may be implemented by the fog layer. The certificate authority (CA) certificate may be configured to authenticate the CA signature on the certificate, as part of the authorizations before launching a secure connection or transferring data. A certificate authority or certification authority (CA) is an entity that issues digital certificates. A digital certificate may certify the ownership of a public key by the named subject of the certificate. The certificates may have system defined formats or can be proprietary certificates as described later herein. The fog layer may comprise other fog applications 323 to perform one or more tasks as described above. In some cases, the fog applications, fog CA may be managed by a management console 325 running on the cloud.

In some cases, the process of attesting that a workload is ready for deployment can be done by utilizing host-agents and/or deployment specific agents in the fog layer (e.g., fog CA 321, 323, kubernetes-api-server, kubectl agent) or vCenter information. For instance, the fog layer may verify the guarantor instance running on a container of a given Pod (basic execution unit of a Kubernetes application) and then check if the container and guarantor conforms to the secure management system fortified case. In an example, a guarantor may perform fog attestation by sending container-id, pid, binary path, bin cksum, and process start time. The fog layer may run a command to verify a guarantor's report. In some cases, a fraudulent guarantor may be detected by catching it sending an invalid container-id multiple times, which does not match the cid/pid/startup-time. In some cases, to provide additional security, a two-factor mechanism may be provided. For example, a guarantor process may open a UDS (Unix domain socket) or inter-process communication socket after sending an initial attestation request, the fog layer may “kubectl exec” to write a random number (e.g., nonce) to the UDS socket, the guarantor may then report the nonce in its final attestation request for authentication. The attestation method can be conveniently extended to VM scenario. For instance, the fog CA may generate a random number to the VM guarantor (AWS EC2 scenario), the VM guarantor may utilize its AWS IID Spec PKCS7 private key to sign it and send it back in the final attestation message, then the fog CA may verify its validity based on public key of the EC2 instance.

In alternative cases, the guarantor can be attested by the infrastructure and assigned a verifiable cryptographic identity after successful attestation and the trust boundary may be extended to the secure agent process. Subsequently any flow that is intercepted by this secure agent process can provide more granular verification of the co-resident agent.

During the fortification process, various binaries and libraries installed in the container may be scanned. In some cases, the fortification process may be improved by caching previous layers of scanned binary/library information and overlaying the previous layers with higher layered changes to effectively derive the final container image's scanned binary/library information. The scanned container data base may have a mapping between the a file's absolute path to the associated metadata. The metadata may contain the creation/last-update timestamp, size, checksum of the file content, CVE data-base known vulnerability mapping and the like. A fortified container's scanned database can be stored in the backend.

During the attestation process, the fog layer may retrieve the scanned data information pertaining to the attesting container and upon successful attestation, the fog layer may pass this information to the guarantor process in the container. For an intercepted flow, when the guarantor process fetches the process information, it may cross-verify the process by checking the process' dynamic binary information such as current binary file's checksum against information retrieved from the scanned-database. When there is a mismatch, the guarantor may alert the end-user about any malicious activity, quarantine the process from communicating or stop the process.

In some scenarios, a malicious code may not present or create new binaries or spawn a new process from that malicious binary using fork/exec mechanism. Rather, the malicious code may modify the current binary. To prevent such attacks, the memory mapped instruction segments of the running processes can be periodically scanned to determine if any modification has generated by a malicious code.

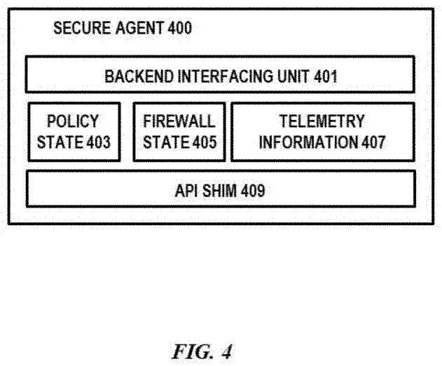

FIG. 4 schematically shows a block diagram of an example secure agent 400, in accordance with various embodiments of the invention. In some embodiments, the secure agent 400 may be in communication with a security management system. The secure agent may comprise a shim layer cleanly intercepts all the API calls that the application intends to make to the C runtime (such as libc). The shim layer may be capable of intercepting the communication APIs. Since the C runtime provides access to the resources of the operating system such as memory, storage, network and the like, the secure agent may process all the triggers and provide policy-based access to any of these resources the workload (e.g., application) requests for. The secure agent may secure network access and provide network firewall functionality embedded in the application.

As described above, the secure agent may be cryptographically secured during the process of embedding in the application binary. Authentication information (e.g., certificates) may be used to verify authenticity by the backend security management system. The authentication information (e.g., certificates) may also be used to establish secure communication channels between secure agents or workloads. For example, an application with embedded secure agent communicating with another application with embedded secure agent, may verify each other by validating the respective cryptographic signatures. In another example, metadata such as process lineage, security labels and/or binary checksum or other selectors such as kubernetes labels or vCenter tags may be digitally signed by each communicating agent's cryptographic keys and may be verified by the peer agent. The signature may be verified based on a common trusted ancestor certificate which belongs to a digital certificate signed by the secure management system. Failure to verify may result in raising an alert. In some cases, the secure agent may verify if the certificate is a valid certificate based on the digital signature included in the certificate. The secure agent may then store and manage the signed certificate associated with the endpoint/workload in a local database.

In some embodiments, the secure agent may comprise a compatibility layer such as an API shim layer 409. The API shim layer may be a C Runtime shim layer that emulates the C runtime API provided by libraries such as libc and OpenSSL. This may advantageously allow for minimal change to the application code and can be embedded into the application binary without involvement of the application owner/writer. In some cases, the shim layer may review all API requests, records relevant pieces of data for visibility, monitoring or analytics and/or blocks a set of API requests that violate a specified policy.

The secure agent may comprise a memory unit to store data related to policy state, firewall state and telemetries. The policy state 403 may hold the policies, including but not limited to whitelist, blacklist, or threat signatures and the like. Traffic originating and destined to the application may be validated against this policy state and corresponding action may be taken. The policy state may be configured at application instantiation time. The policy state may be instantly updated by the backend security management system based on new threat discovery or upon detection of configuration change.

The firewall state 405 may hold the application security posture and the active firewall state. The firewall state 405 may include flows and statistics, and may perform the firewall function based on the policy configured for the application. This firewall state 405 may be built (at runtime) as the application starts to interact with other applications in the network. This firewall state 405 may also perform analysis such as IDS/IPS (Intrusion Detection/Prevention Systems) analysis to detect and mitigate things like SQL Injection or buffer overflow attacks. In some cases, the firewall state may be transferred using a handshake/challenge protocol.

The telemetry information 407 may include flow data and metadata (e.g., logs, destination, port number, Layer-7 information such as http headers, URL, RPC/REST-api endpoint, topics, or application signatures, metadata) and other data as described elsewhere herein. The telemetry information may be pushed to the backend security management systems for further analysis.

The secure agent 400 may comprise a backend interfacing unit 401 for establishing and maintaining communication with the security management system. For example, the secure agent 400 may discover the security management system on the network and maintain a perpetual secure connection with the security management system so that it can stream telemetry and fetch updated security policy. In the case where the security management system is not reachable, the secure agent 400 may continue to apply the policy it previously had and reconciles with the security management system once the connection is restored. Alternatively or in addition to, policies can be pushed down to agents using a distributed consensus database such as CoreOS-Etcd, Apache-ZooKeeper, Consul or by utilizing a message stream distribution solution such as Apache-Kafka.

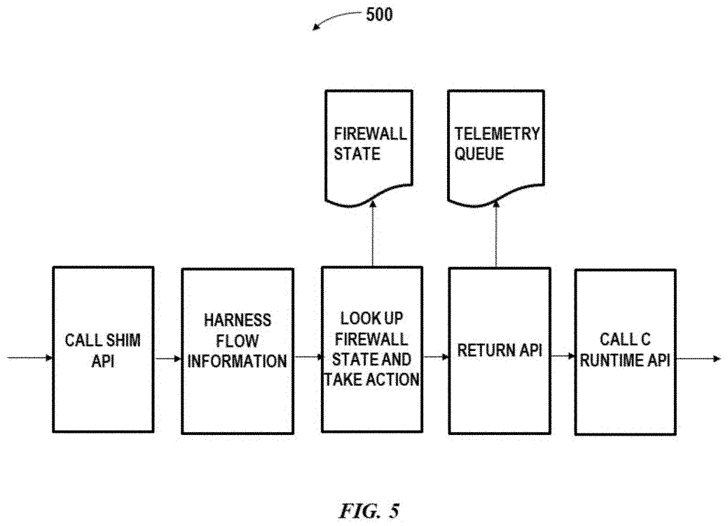

FIG. 5 shows an example internal process 500 of implementing security policies with a secure agent. The process 500 can provide security policies at the shim layer. The process 500 can be adapted for any policy-based operations (e.g. various security operations). In the example, the workload may be an application that is to send a payload to the network. The application may first make a call (e.g., send( )″) to the API shim. Next, the API shim's send( )″ API may be invoked. The API shim may harness the data and metadata such as the destination the application is trying to reach or the port number. The API shim may also parse Layer-7 information such as headers, URL, RPC/REST-api endpoint, topics, or application signatures, and metadata such as application type, Kubernetes labels, and the like. The secure agent may then look up firewall policy and runtime state to determine if this payload is allowed. If it is denied based on the policy, the call may be returned with an error. A firewall policy may include but not limited to, a simple access policy (permit/deny), or a simple anomaly engine that works in concert with the backend system (e.g. detect/alert/mitigate data exfiltration when more than normal amount of data is seen to be transferred outside). The firewall policy may include any other policies as described elsewhere herein. Actions may be taken upon executing the firewall policy. For instance, an error may be returned and/or an alert may be generated when the action is to deny. In case the call passes all checks, the real send( ) routine implemented by OS service may be invoked to send the payload out. Telemetry data may be recorded and pushed to the telemetry queue. The telemetry data may be transmitted to the backend security management system based on a pre-determined schedule (e.g., periodically) or upon detection of an event. In some cases, the policy application can be performed during TCP/UDP socket establishment time such as by trapping socket connect( ) call.

The provided method and systems may have the ability to apply existing firewall policies as well as firewall policies at a fine-grained level such as per API level, per resource served by the application and obeying principles of least privilege, at an application level, or at a group of applications level. An application group can be identified by a higher level entity such as a Kubernetes label. Unlike the conventional method using IP Addresses or Port Numbers, the provided method and system advantageously allows for applying the policies at the fine controlled level.

Traditional firewall may apply policies based on contents of the payload data that is being transferred such as Layer-3 (IP addresses) and Layer-4 (TCP/UDP port numbers). For instance, the secure agent may execute an action according to the policy determined based on the source and destination to, for example, permit or allow the flow described in the policy (i.e., forward the communication), block or deny the flow described in the policy (i.e., drop the communication), limit the bandwidth consumed by the flow (i.e., rate-limit), log the flow, “mark” the flow for quality of service (QoS) (e.g., set a lower or higher priority for the flow), redirect the flow (e.g., to avoid critical paths), copy the flow, and various other actions.

With the application of the provided systems, the security policy can be based on data of Layer-7, other attributes or metadata. The security policy may be applied based on an identity of the entity requesting an access to a resource and/or an identity or type of the resource to be accessed. For example, metadata may include data that is available on the client side that may be lost in translation. For instance, source IP is usually overloaded with data related to location, user, application, and the like when the packet is processed at the server/service side. Such metadata or attributes (e.g., user, process, subnet, geographical location and the like) may be sent as labels in a proprietary encapsulation and used in making policy decisions on the receiving side. In some cases, such metadata or attributes may be encapsulated and transmitted to the security management system by the secure agents. In an example, consider a case where Application-A invokes a Restful API of an endpoint provided by Application-B to retrieve a set of data and the data requested by the application-A is the result of a request coming from User-1. If the policy of allowing the rest API to retrieve data is based on the requestor (i.e., Application-A), it may always be allowed. However, if the policy to retrieve data taking into account the fact that User-1 is the entity requesting this data, the policy paradigm may allow for fine control that takes into account of useful factors (e.g., user, type of user, identity of user, etc). In the above example, the secure agent of Application-1 may embed the metadata information in the request (e.g., by means of adding http headers for example), which may then be leveraged for policy application by the secure agent on Application-2, before removing them prior to delivering it to the upper layers of Application-2.

Below is a list of examples of policies can be applied by the provided systems or methods.

### EXAMPLE 1

### Traditional Policies

src ip=“1.1.1.1”, dst_ip=“2.2.2.2”, dst_port=“3300”, action=“permit”

deny all

In this example, only one source IP (1.1.1.1) is allowed to communicate to the service running on 2.2.2.2 (represented by port 3300). Everything else is denied.

### EXAMPLE 2

### Deep Policies

src ip=“sap-app”, dst=“database”, action=“permit”

deny all

In this example, the policy is based on application/service rather than an IP address. The policy may allow communication between the two applications (and instances thereof). In the previous example, any application on sap-app would have been able to access the database service.

### EXAMPLE 3

### Tight Policies

src ip=“sap-app”, dst=“database”, dst_resource=“employees”, action=“permit”

deny all

In this example, the policy may restrict further to define which topic/table within database is being authorized for sap-app.

### EXAMPLE 4

### Policies Using Other Attributes

user==“userA”, src ip=“sap-app”, dst=“database”, dst_resource=“employees”, action=“permit”

deny all

In some embodiments, the secure management system may employ a policy paradigm comprising location-transparent service-policies that can be deployed in multiple environments/locations with minimal input from users. In some cases, the location-transparent service-policies may specify different types of connections such as east-west connections and external north/south connections, permitted between two or more entities. The policies may specify which connections between entities are permitted. If a connection is permitted, an entity may connect to and communicate with its dependency. If a connection is not permitted, then an entity may not connect to or communicate with its dependency. In some cases, in the context of a collection of entities (e.g., a service is a collection of processes), east-west connection may refer to a connection within the collection, a north connection may refer to a connection from outside the collection to inside the collection, and a south connection may refer to a connection from inside the collection to outside the collection. The connection may be unidirectional. For example, when two entities need to initiate connections with each other, two connections may need to be permitted between them as specified by the policies.

A service may be a collection of communicating processes/nested-services. The processes/nested-services in a service may have north, south, and east-west connections. A service-policy may specify the connections permitted in a service. A service may also be referred to as an application. For east-west connections, the entities are all within the service and may be identified by the service-policy. For north and south connections, one entity is in the service thus can be identified by the service-policy while the external entity may not be identified by the service-policy, the service-policy may use placeholders for such external entities.

In some embodiments, the provided policy paradigm may be whitelist policies that are used to enforce legitimate communication within a network/system. The location-transparent service policies can be reused in various environments. For example, services can run in various environments such as production, staging, test, per-developer, and other different stages. Environments may also be different based on geographic regions, or subdivided by geographic region such as ‘production.east’, ‘production.west’, ‘staging.us’, ‘staging.eu’, and the like. A service can be instantiated in multiple environments, and set up to have dependencies in the same environment or in different environments. An environment may be a collection of services. The collection services in an environment may have north, south, and east-west connections. An environment-policy may specify the connections permitted in an environment. Environment-policies can be used to create environments. The name of the environment policy may not need to match the name of the created environment. An environment-policy can be used to create multiple environments. For example, developers may recreate their own instance of a production environment for development/debugging.

The location-transparent service-policies can be retrieved and deployed in an automated fashion. For example, users may specify an environment tag and a service-name tag when deploying their services. Interceptor-processes report may be generated with these two tags as well as process-related information discovered by the interceptor-processes. Using these tags, the secure management system may be able to monitor all flows within the service (e.g., east-west flows), flows from outside the service to inside the service (e.g., north flows), and flows from inside the service to outside the service (e.g., south flows). Placeholders may be created for north and south flows.

The provided policy paradigm may allow for dynamic composition of location-transparent policies based on existing or deployed policies/services. The location-transparent policies can be composed to conform to an existing policy or deployed service. For instance, a set of location-transparent policies may be composed dynamically to create a new location-transparent policy that mirrors the composing of deploy services. The newly composed service policies may be flattened and sent to the interceptor-processes for enforcement.

The secure agent may interact with a backend security management system to provide telemetry and/or to fetch the security policy for the workload. In some cases, the security policy may be derived automatically based on realtime telemetry data. For example, the contextual information about the communication peers extracted from the flow telemetry data may be used to derive a whitelist policy which can then be used to enforce legitimate communication with the network. As described above, the telemetry data may be application contextual data and/or flow telemetry data that captures rich contextual information about the communicating peers. Flow telemetry data may contain ephemeral information such as flow time stamp and/or statistics, environment, process binary or parent binary, process arguments and other associated run-time tags. In an example process of fetching the security policy, a pair of flow telemetry (coming from sender and receiver side of a secure agent) may be captured and normalized to remove the ephemeral information or ephemeral selectors. A set of sender selectors and receiver selectors may be created to form a mapping from one set of selectors associated with the sender (e.g., source selectors) to a set of selectors associated with the receiver (e.g., destination selectors). The occurrence of the same or similar mappings may be counted. In some cases, the mappings (source-destination selector mappings) may be directly converted into a policy where the source-destination selector mapping may become an ingress policy at the destination and/or egress policy at the source. These policies may be layer-7 policy that may contain rich contextual information (e.g. source/dest container image, source/dest container's kubernetes pod selectors, source/dest process binary, path, cmd line arguments) compared to conventional policies. Next, data mining algorithms such as Apriori algorithm may be applied to create strong policies using association which have minimum support and use minimum threshold for admissible policies. This mechanism can be useful to identify strong association in a communication pattern.

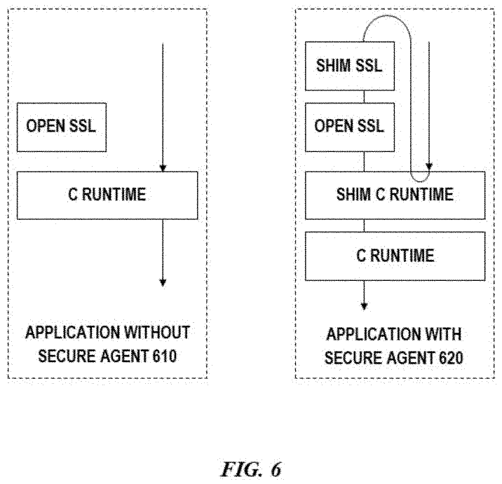

The provided systems and methods may be capable of converting insecure workload into secure workload seamlessly and dynamically. For example, application services that interact with other services over open channels may automatically be converted to secure/encrypted communications without the need to change the application core logic or the source code. FIG. 6 shows an example of converting insecure workload 610 into a secure workload 620. In this case, an application making a connect( ) API call is intercepted and translated to an OpenSSL API to invoke a secure socket (which also acts as a digital signature for the purposes of non-repudiation). Alternatively, the secure agent could potentially leverage advanced functionality such as socket-redirect and Kernel TLS to offload the encryption work. The secure agent may be configured to decide such functionalities based on the platform (e.g., workload provider) capabilities and ability to offload. If the other end of the socket is an application with a secure agent, it may accept the secure connection, decrypt the traffic and provide clear data to the receiving application without having to change the application.

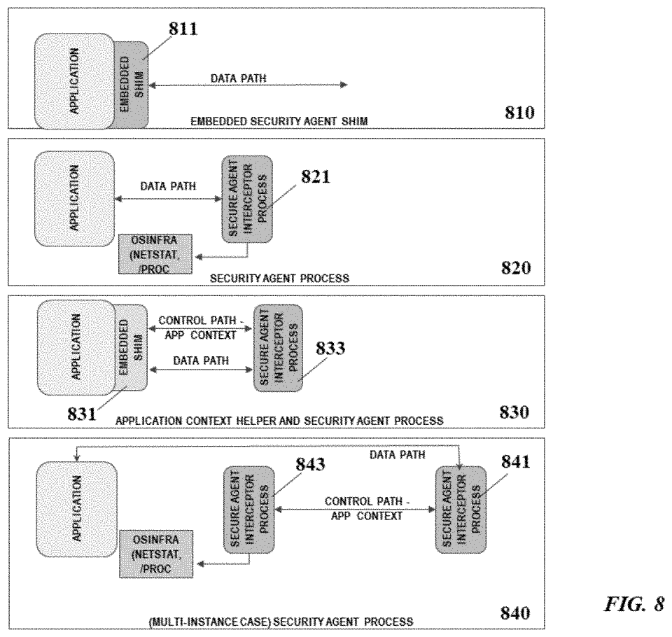

FIG. 8 schematically shows various deployments of the secure agent and an interceptor. In the examples, the workload is an application. As illustrated in the first scenario 810, a secure agent shim 811 may be embedded in the application. The secure agent may perform various functions such as fetching the context of the application, enforcing a policy, data path functionalities such as performing deep-packet operation (e.g., packet interception, packet inspection) as described elsewhere herein. In the second scenario 820, the secure agent is implemented as a secure agent interceptor process 821 which may intercept networks connections, apply policies and fetch the application contextual data using suitable techniques (e.g., netstat and/proc walks). The interceptor process can be the same as the interceptor process as described elsewhere herein. In the third scenario 830, a combination of the secure agent shim 831 and a secure agent interceptor process 833 may be employed in the security management system. The data path functionality (e.g., performing deep-packet operation) may be performed by the secure agent interceptor process 833 and control path functionalities such as application contextual data fetching may be performed by the embedded secure agent shim 831. In a multi container scenario (e.g. Kubernetes pod with multiple containers) 840, a master-slave secure agent mechanism may be employed. the data path functionality may be performed by the master secure agent 841 (e.g., master secure agent interceptor process) which shares the network namespace with the application. The control path functionalities such as fetching application context may be performed via a control channel by the slave secure agent 843 (e.g., slave secure agent interceptor process).

### Computer Systems

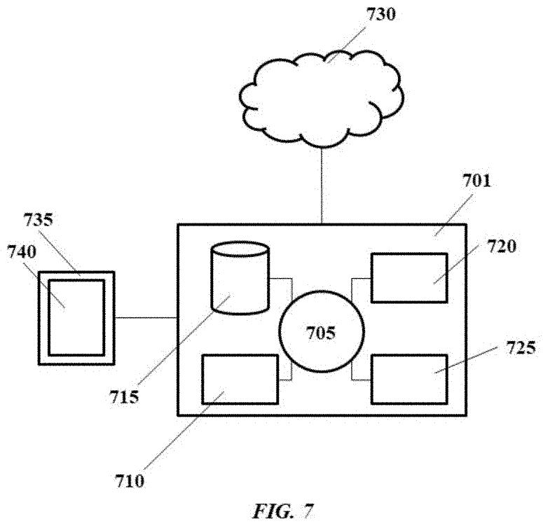

The security management system or processes described herein can be implemented by one or more processors. In some embodiments, the processor may be a processing unit of a computer system. FIG. 7 shows a computer system 701 that is programmed or otherwise configured to implement the security management system. The computer system 701 can regulate various aspects of the present disclosure. The computer system 701 can be an electronic device of a user or a computer system that is remotely located with respect to the electronic device. The electronic device can be a mobile electronic device.

The computer system 701 includes a central processing unit (CPU, also “processor” and “computer processor” herein) 705, which can be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage and/or electronic display adapters. The memory 710, storage unit 715, interface 720 and peripheral devices 735 are in communication with the CPU 705 through a communication bus (solid lines), such as a motherboard. The storage unit 715 can be a data storage unit (or data repository) for storing data. The computer system 701 can be operatively coupled to a computer network (“network”) 730 with the aid of the communication interface 720. The network 730 can be the Internet, an internet and/or extranet, or an intranet and/or extranet that is in communication with the Internet. The network 730 in some cases is a telecommunication and/or data network. The network 730 can include one or more computer servers, which can enable distributed computing, such as cloud computing. The network 730, in some cases with the aid of the computer system 701, can implement a peer-to-peer network, which may enable devices coupled to the computer system 701 to behave as a client or a server.

The CPU 705 can execute a sequence of machine-readable instructions, which can be embodied in a program or software. The instructions may be stored in a memory location, such as the memory 710. The instructions can be directed to the CPU 705, which can subsequently program or otherwise configure the CPU 705 to implement methods of the present disclosure. Examples of operations performed by the CPU 705 can include fetch, decode, execute, and writeback.

The CPU 705 can be part of a circuit, such as an integrated circuit. One or more other components of the system 701 can be included in the circuit. In some cases, the circuit is an application specific integrated circuit (ASIC).

The storage unit 715 can store files, such as drivers, libraries and saved programs. The storage unit 715 can store user data, e.g., user preferences and user programs. The computer system 701 in some cases can include one or more additional data storage units that are external to the computer system 701, such as located on a remote server that is in communication with the computer system 701 through an intranet or the Internet.

The computer system 701 can communicate with one or more remote computer systems through the network 730. For instance, the computer system 701 can communicate with a remote computer system of a user (e.g., a user device). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 701 via the network 730.

Methods as described herein can be implemented by way of machine (e.g., computer processor) executable code stored on an electronic storage location of the computer system 701, such as, for example, on the memory 710 or electronic storage unit 715. The machine executable or machine readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 701 can include or be in communication with an electronic display 735 that comprises a user interface (UI) 740 for providing, for example, a graphical user interface for displaying security analytics captured by one or more secure agents or the security management system. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 705. The algorithm can, for example, trained models such as interpreters, sentimental analysis module.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A system for securing a computer workload within a network comprising:
(a) a secure agent, wherein the secure agent comprises an interfacing layer embedded into the computer workload for intercepting application programming interface (API) calls and wherein the secure agent is configured to apply a security policy based at least in part on the API calls intercepted by the interfacing layer; and
(b) a server in communication with the secure agent, wherein the server is configured to analyze telemetry data captured by the secure agent to secure the computer workload.

2. The system of claim 1, wherein the computer workload is a container application or a computing processing that is performed by a bare metal, virtual machine or a combination of Kubernetes and server.

3. The system of claim 1, wherein the interfacing layer is a shim layer that is located between an application libraries layer of the computer workload and an operating system service layer.

4. The system of claim 1, wherein the interfacing layer comprises a dynamically linked library.

5. The system of claim 1, wherein the telemetry data comprises application contextual data, metadata or flow telemetry data.

6. The system of claim 1, wherein the server is configured to perform behavioral analysis of the computer workload based on the telemetry data.

7. The system of claim 1, wherein the server is configured to monitor and record a history of the telemetry data at an API level.

8. The system of claim 1, wherein the security policy is applied based on an identity of an entity requesting an access to a resource or an identity of the resource to be accessed.

9. The system of claim 1, wherein the security policy specifies a connection between two entities in the network.

10. The system of claim 1, wherein the security policy comprises a service policy specifying a connection in a service.

11. The system of claim 1, wherein the security policy comprises an environment policy specifying a connection permitted in an environment.

12. The system of claim 1, wherein the security policy is applied at Layer-7 of the OSI (Open Systems Interconnection) Network model.

13. The system of claim 1, wherein the security policy is automatically derived from the telemetry data.

14. The system of claim 1, wherein the secure agent is cryptographically secured.

15. The system of claim 1, wherein the secure agent is in communication with an interceptor, and wherein the interceptor is configured to intercept a data flow and apply the security policy on the data flow.

16. The system of claim 15, wherein the interceptor and the secure agent forms a master-slave relationship.

17. The system of claim 1, wherein the secure agent comprises a memory unit to store data related to a policy state, a firewall state and the telemetry data.

18. The system of claim 1, wherein the secure agent is configured to perform packet interception or packet inspection.

19. A method for securing a computer workload within a network comprising:
(a) receiving the computer workload in the network;
(b) embedding a secure agent into the computer workload, wherein the secure agent comprises an interfacing layer for intercepting application programming interface (API) calls; and
(c) applying, based at least in part on the API calls intercepted by the interfacing layer, a security policy to secure the computer workload.

20. (canceled)

21. The method of claim 19, wherein the interfacing layer is a shim layer that is located between an application libraries layer of the computer workload and an operating system service layer.

22.-47. (canceled)
